(19) United States
(12) Patent Application Publication
(10) Pub. No.: US 2005/0131697 A1
(43) Pub. Date: Jun. 16, 2005

(54) Speech improving apparatus, system and method

(75) Inventors: Michael Wayne Brown, Georgetown, TX (US); Michael A. Paolini, Austin, TX (US); Newton James Smith JR., Austin, TX (US); Lorin Evan Ullmann, Austin, TX (US); Cristi Nesbitt Ullmann, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/732,781

(22) Filed: Dec. 10, 2003

(51) Int. Cl. G10L 21/00

(52) U.S. Cl. 704/270

(57) ABSTRACT

A speech making improving system, apparatus and method are provided. During a videoconference, participants are video-recorded. Data representing participants who exhibit expressions during the video-conference may be stored for further analyses. To do an analysis, an expression to be searched for may have to first be indicated. Once done, a determination, using the stored data in conjunction with an automated facial decoding system, whether at least one participant exhibited the indicated expression may be made. Then, video data representing the participant who exhibited the expression and the audio data representing what was being said when the participant exhibited the expression may be analyzed to improve a speaker's speech making ability.

### CROSS-REFERENCE TO RELATED APPLICATIONS

This application is related to co-pending U.S. patent application Ser. No. ______ (IBM Docket No. AUS920030335US1), entitled APPARATUS, SYSTEM AND METHOD OF AUTOMATICALLY IDENTIFYING PARTICIPANTS AT A VIDEOCONFERENCE WHO EXHIBIT A PARTICULAR EXPRESSION by the inventors herein, filed on even date herewith and assigned to the common assignee of this application.

This application is also related to co-pending U.S. patent application Ser. No. ______ (IBM Docket No. AUS920030585US1), entitled TRANSLATING EMOTION TO BRAILLE, EMOTICONS AND OTHER SPECIAL SYMBOLS by Janakiraman et al., filed on Sep. 25, 2003 and assigned to the common assignee of this application, the disclosure of which is incorporated by reference.

### BACKGROUND OF THE INVENTION

1. Technical Field

The present invention is directed to an analyzing tool. More specifically, the present invention is directed to a speech improving apparatus, system and method.

2. Description of Related Art

Due to recent trends toward telecommuting, mobile offices, and the globalization of businesses, more and more employees are being geographically separated from each other. As a result, less and less face-to-face communications are occurring at the workplace.

Face-to-face communications provide a variety of visual cues that ordinarily help in ascertaining whether a conversation is being understood or even being heard. For example, non-verbal behaviors such as visual attention and head nods during a conversation are indicative of understanding. Certain postures, facial expressions and eye gazes may provide social cues as to a person's emotional state, etc. Non-face-to-face communications are devoid of these cues.

To diminish the impact of non-face-to-face communications, videoconferencing is increasingly being used. A videoconference is a conference between two or more participants at different sites using a computer network to transmit audio and video data. Particularly, at each site there is a video camera, microphone, and speakers mounted on a computer. As participants speak to one another, their voices are carried over the network and delivered to the other's speakers, and the images which appear in front of a video camera appear in a window on the other participant's monitor.

As with any conversation or in any meeting, sometimes a participant might be stimulated by what is being communicated and sometimes the participant might be totally disinterested. Since voice and images are being transmitted digitally, it would be advantageous to store this data to be used later as a speech improving apparatus, system and method.

### SUMMARY OF THE INVENTION

The present invention provides a speech making improving system, apparatus and method. During a videoconference, participants are video-recorded. Data representing participants who exhibit expressions during the video-conference may be stored for further analyses. To do an analysis, an expression to be searched for may have to first be indicated. Once done, a determination, using the stored data in conjunction with an automated facial decoding system, whether at least one participant exhibited the indicated expression may be made. Then, video data representing the participant who exhibited the expression and the audio data representing what was being said when the participant exhibited the expression may be analyzed to improve a speaker's speech making ability.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 depicts a representative videoconference computing system.

FIG. 5 is a block diagram of a videoconferencing device.

FIG. 6 depicts a representative graphical user interface (GUI) that may be used by the present invention.

FIG. 7 depicts a representative GUI into which a participant may enter identifying information.

FIG. 8 depicts an example of an expression charted against time.

FIG. 9 is a flowchart of a process that may be used by the invention.

### DETAILED DESCRIPTION OF THE PREFERRED EMBODIMENT

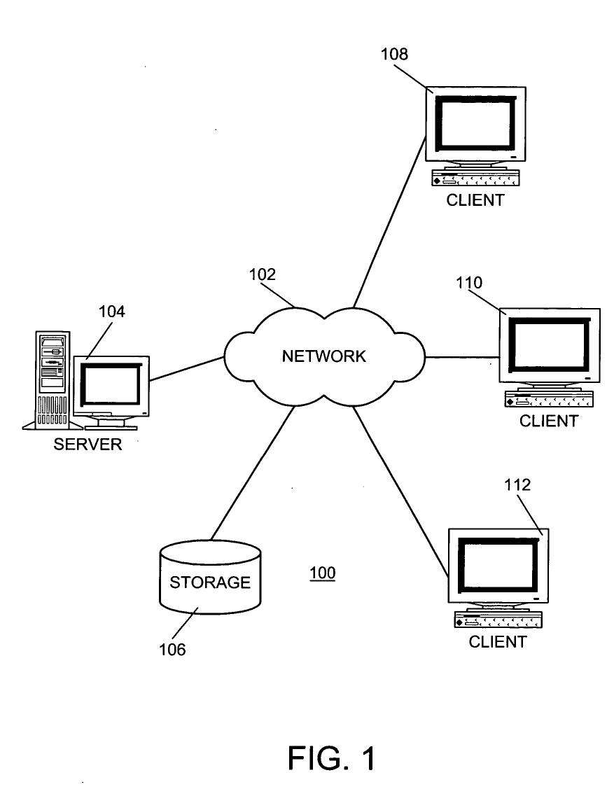

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

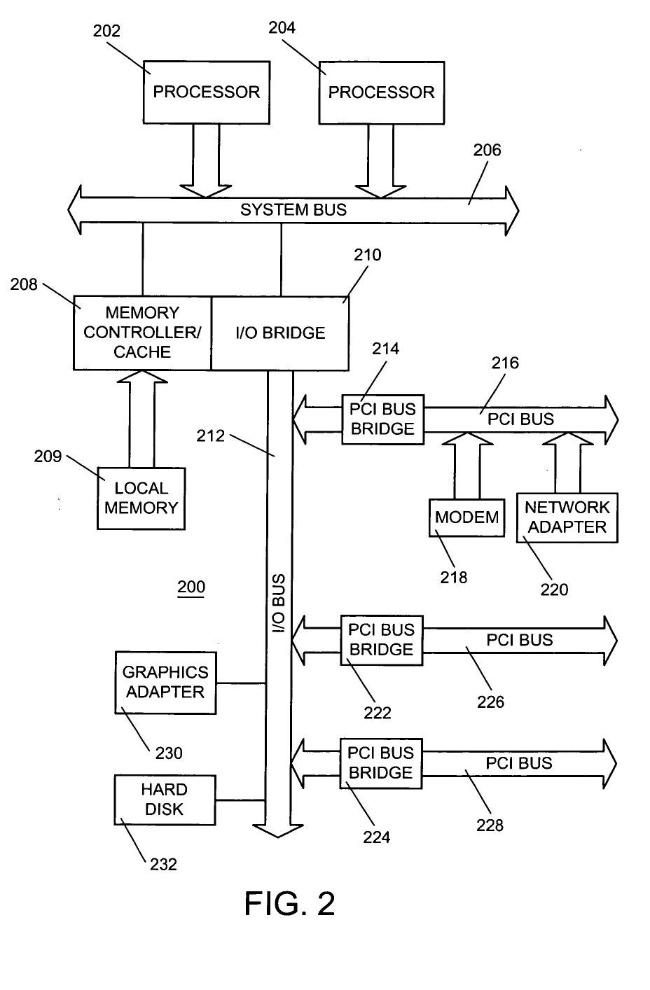

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or the LINUX operating system.

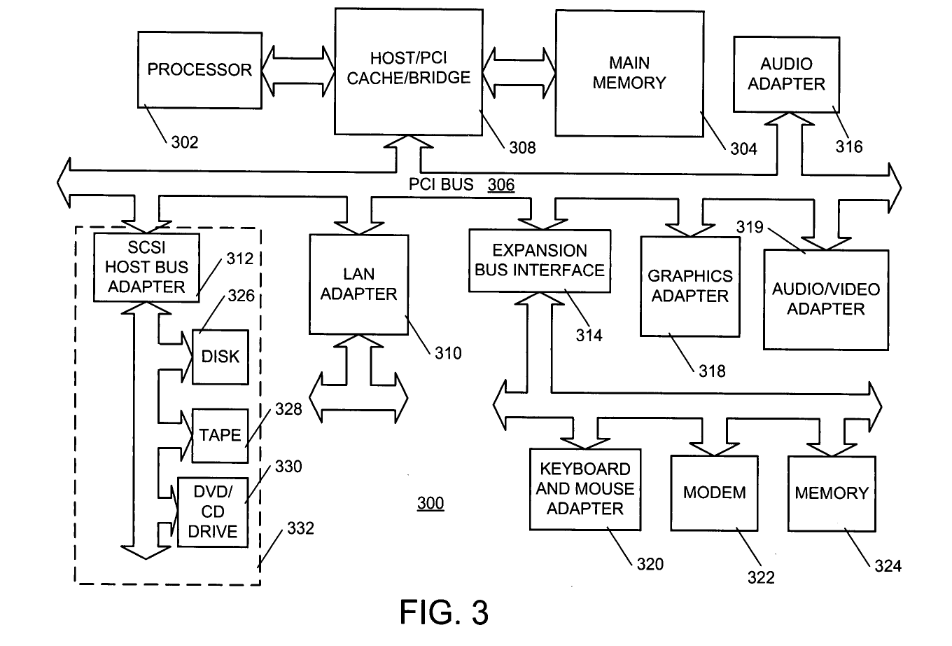

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and DVD/CD drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming environment such as Java may run in conjunction with the operating system and provide calls to the operating system from Java programs or applications executing on data processing system 300. “Java” is a trademark of Sun Microsystems, Inc. Instructions for the operating system, the object-oriented programming environment, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides a speech improving tool. The invention may reside on any data storage medium (i.e., floppy disk, compact disk, hard disk, ROM, RAM, etc.) used by a computing system. Further, the invention may be local to client systems 108, 110 and 112 of FIG. 1 or to the server 104 and/or to both the server 104 and clients 108, 110 and 112.

It has well been known that unconscious facial expressions of an individual generally reflect true feelings and hidden attitudes of the individual. In a quest of enabling inference of emotion and communicative intent from facial expressions, significant effort has been made in automatic recognition of facial expressions. In furtherance of this quest, various new fields of research have been developed. One of those fields is Automated Face Analysis (AFA).

AFA is a computer vision system that is used for recording psychological phenomena and for developing human-computer interaction (HCl). One of the technologies used by AFA is Facial Action Coding System (FACS). FACS is an anatomically based coding system that enables discrimination between closely related expressions. FACS measures facial actions where there is a motion recording (i.e., film, video, etc.) of the actions. In so doing, FACS divides facial motion into action units (AUs). Particularly, a FACS coder dissects an observed expression, decomposing the expression into specific AUs that produced the expression.

AUs are visibly distinguishable facial muscle movements. As mentioned above, each AU or a combination of AUs produces an expression. Thus, given a motion recording of the face of a person and coded AUs, a computer system may infer the true feelings and/or hidden attitudes of the person.

For example, suppose a person has a head position and gaze that depart from a straight ahead orientation such that the gaze is cast upward and to the right. Suppose further that the eyebrows of the person are raised slightly, following the upward gaze, the lower lip on the right side is pulled slightly down, while the left appears to be bitten slightly. The jaw of the person may be thrust slightly forward allowing the person's teeth to engage the lip. The person may be said to be deep in thought. Indeed, the gaze together with the head position suggests a thoughtful pose to most observers.

In any case, an AU score may have been accorded to the raised eyebrow, the slight pulled-down lower lip, the lip biting as well as the jaw thrust. When a computer that has been adapted to interpret facial expressions observes the face of the person, all these AUs will be taken into consideration including other responses that may be present such as physiological activity, voice, verbal content and the occasion when the expression occurs, to make an inference about the person. In this case, it may very well be inferred that the person is in deep thought.

Thus, the scores for a facial expression consist of the list of AUs that produced it. Duration, intensity, and asymmetry may also be recorded. AUs are coded and stored in a database system.

The person-in-thought example above was taken from DataFace, Psychology, Appearance and Behavior of the Human Face at http://face-and-emotion.com/dataface/expression/interpretations.html. A current hard copy of the Web page is provided in an Information Disclosure Statement, which is filed in conjunction with the present Application and which is incorporated herein by reference. Further, the use of AUs is discussed in several references. Particularly, it is discussed in Comprehensive Database for Facial Expression analysis by Takeo Kanade, Jeffrey F. Cohn and Yingli Tian, in Bimodal Expression of Emotion by Face and Voice by Jeffrey F. Cohn and Gary S. Katz and in Recognizing Action Units for Facial Expression Analysis by Yingli Tian, Takeo Kanade and Jeffrey F. Cohn, which are all incorporated herein by reference.

The present invention will be explained using AUs. However, it is not thus restricted. That is, any other method that may be used to facilitate facial expression analyses is well within the scope of the invention. In any case, the database system in which the coded AUs are stored may be local to client systems 108, 110 and 112 of FIG. 1 or to the server 104 and/or to both the server 104 and clients 108, 110 and 112 or any other device that acts as such.

As mentioned in the Background Section of the invention, in carrying out a videoconference, each participant at each site uses a computing system equipped with speakers, video camera and microphone. A videoconference computing system is disclosed in Personal videoconferencing system having distributed processing architecture by Tucker et al., U.S. Pat. No. 6,590,604 B1, issued on Jul. 8, 2003, which is incorporated herein by conference.

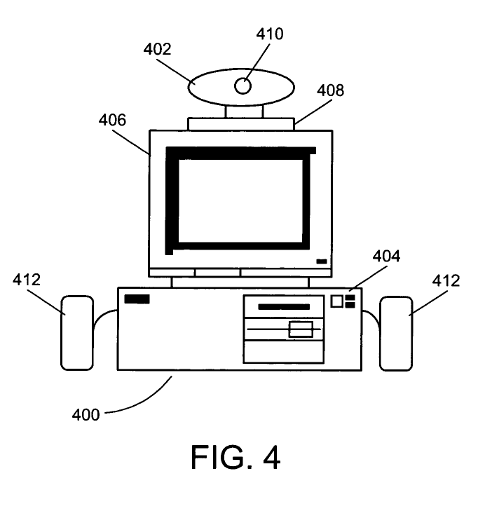

FIG. 4 depicts such a videoconference computing system. The videoconferencing system (i.e., computing system 400) includes a videoconferencing device 402 coupled to a computer 404. The computer 404 includes a monitor 406 for displaying images, text and other graphical information to a user. Computer system 404 is representative of clients 108, 110 and 112 of FIG. 1.

The videoconferencing device 402 has a base 408 on which it may rest on monitor 406. Device 402 is provided with a video camera 410 for continuously capturing an image of a user positioned in front of videoconferencing system 400. The video camera 410 may be manually swiveled and tilted relative to base 408 to properly frame a user's image. Videoconferencing device 402 may alternatively be equipped with a conventional camera tracking system (including an electromechanical apparatus for adjusting the pan and tilt angle and zoom setting of video camera 410) for automatically aiming the camera at a user based on acoustic localization, video image analysis, or other well-known techniques. Video camera 410 may have a fixed-focus lens, or may alternatively include a manual or automatic focus mechanism to ensure that the user's image is in focus.

Videoconferencing device 402 may further be provided with a microphone and an interface for an external speaker (not shown) for, respectively, generating audio signals representative of the users' speech and for reproducing the speech of one or more remote conference participants. A remote conference participant's speech may alternatively be reproduced at speakers 412 or a headset (not shown) connected to computer 404 through a sound card, or at speakers integrated within computer 404.

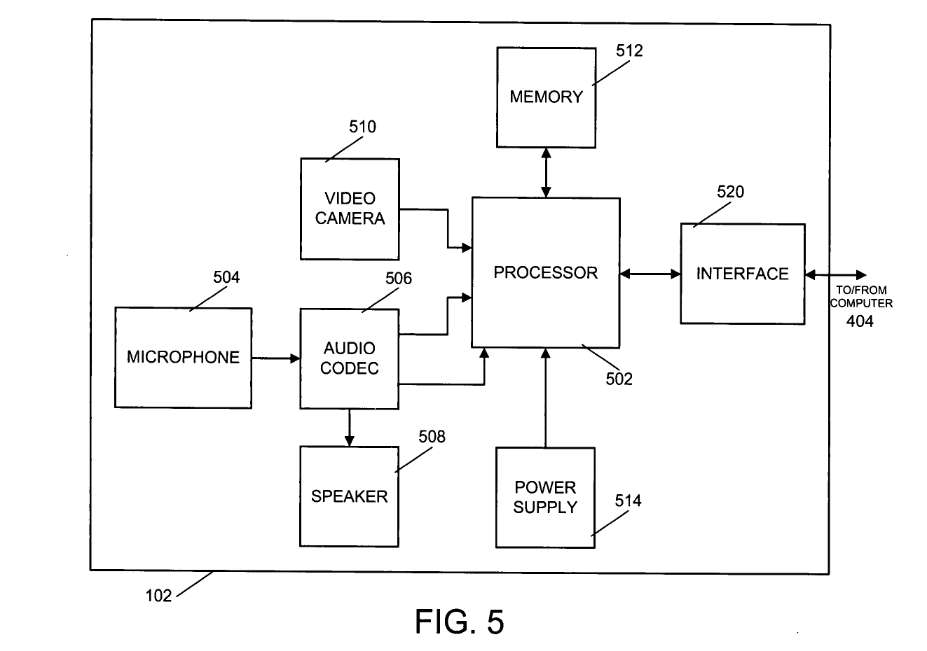

FIG. 5 is a block diagram of the videoconferencing device 402. The video camera 510 conventionally includes a sensor and associated optics for continuously capturing the image of a user and generating signals representative of the image. The sensor may comprise a CCD or CMOS sensor.

The videoconferencing device 402 further includes a conventional microphone 504 for sensing the speech of the local user and generating audio signals representative of the speech. Microphone 504 may be integrated within the videoconferencing device 402, or may comprise an external microphone or microphone array coupled to videoconferencing device 402 by a jack or other suitable interface. Microphone 504 communicates with an audio codec 506, which comprises circuitry or instructions for converting analog signals produced by microphone 504 to a digitized audio stream. Audio codec 506 is also configured to perform digital-to-analog conversion in connection with an incoming audio data stream so that the speech of a remote participant may be reproduced at conventional speaker 508. Audio codec 506 may also perform various other low-level processing of incoming and outgoing audio signals, such as gain control.

Locally generated audio and video streams from audio codec 506 and video camera 510 are outputted to a processor 502 with memory 512, which is programmed to transmit compressed audio and video streams to remote conference endpoint(s) over a network. Processor 502 is generally configured to read in audio and video data from codec 506 and video camera 510, to compress and perform other processing operations on the audio and video data, and to output compressed audio and video streams to the videoconference computing system 400 through interface 520. Processor 502 is additionally configured to receive incoming (remote) compressed audio streams representative of the speech of remote conference participants, to decompress and otherwise process the incoming audio streams and to direct the decompressed audio streams to audio codec 506 and/or speaker 508 so that the remote speech may be reproduced at videoconferencing device 402. Processor 502 is powered by a conventional power supply 514, which may also power various other hardware components.

During the videoconference, a participant (e.g., the person who calls the meeting or any one of the participants) may request feedback information regarding how a speaker or the current speaker is being received by the other participants. For example, the person may request that the computing system 400 flag any participant who is disinterested, bored, excited, happy, sad etc. during the conference.

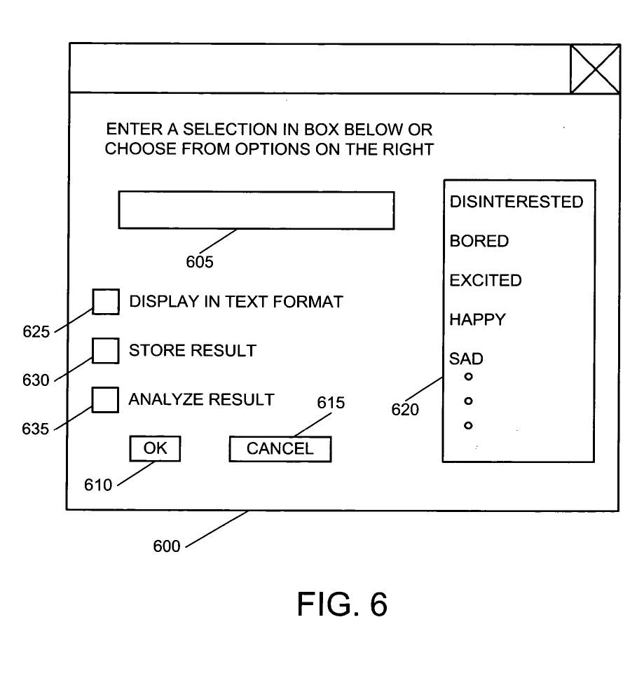

To have the system 400 provide feedback on the participants, a user may depress some control keys (e.g., the control key on a keyboard simultaneously with right mouse button) while a videoconference application program is running. When that occurs, a window may pop open. FIG. 6 depicts a representative window 600 that may be used by the present invention. In the window 600, the user may enter any expression that the user may want the system to flag. For example, if the user wants to know if any one of the participants is disinterested in the topic of the conversation, the user may enter “DISINTERESTED” in box 605. To do so, the user may type the expression in box 605 or may select the expression from a list (see the list in window 620) by double clicking on the left button of the mouse, for example. After doing so, the user may assert the OK button 610 to send the command to the system 400 or may assert CANCEL button 615 to cancel the command.

When the OK button 610 is asserted, the system 400 may consult the database system containing the AUs to continually analyze the participants. To continue with the person-in-thought example above, when the system receives the command to key in on disinterested participants, if a participant exhibits any of the facial expressions discussed above (i.e., raised eyebrows, upward gaze, slightly pulled down of right side of lower lip while left side is being bitten including any physiological activity, voice, verbal content and the occasion when the expression occurs), the computer system may flag the participant as being disinterested. The presumption here is if the participant is consumed in his/her own thoughts, the participant is likely to be disinterested in what is being said.

The computer system 400 may display the disinterested participant at a corner on monitor 406. If there is more than one disinterested participant, they may each be alternately displayed on monitor 406. Any participant who regains interest in the topic of the conversation may stop being displayed at the corner of monitor 406.

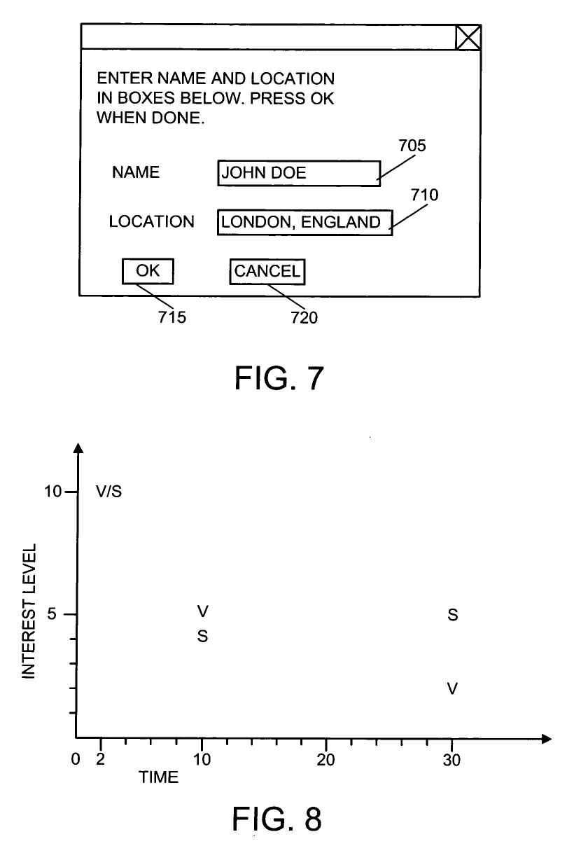

If the user had entered a checkmark in DISPLAY IN TEXT FORMAT box 625, a text message identifying the disinterested participant(s) may be displayed at the bottom of the screen 406 instead of the actual image(s) of the participant(s). In this case, each disinterested participant may be identified through a network address. Particularly, to log into the videoconference, each participant may have to enter his/her name and his/her geographical location. FIG. 7 depicts a representative graphical user interface (GUI) into which a participant may enter the information. That is, names may be entered in box 705 and locations in box 710. When done, the participant may assert OK button 715 or CANCEL button 720.

The name and location of each participant may be sent to a central location (i.e., server 104) and automatically entered into a table cross-referencing network addresses with names and locations. When video and audio data from a participant is received, if DISPLAY IN TEXT FORMAT option 625 was selected, the computer 404 may, using the proper network address, request that the central location provide the name and the location of any participant that is to be identified by text instead of by image. Thus, if after analyzing the data it is found that a participant may appear disinterested, the name and location of the participant may be displayed on monitor 406. Note that names and locations of participants may be also displayed on monitor 406 along with their images.

Note that instead of displaying or in conjunction of displaying a participant who exhibits the expression entered by the user at a corner on the screen 406, the computer system 400 may display a red button at the corner of the screen 406. Further, a commensurate number of red buttons may be displayed to indicate more than one disinterested participant. In the case where none of the participants are disinterested, a green button may be displayed.

In addition, if the user had entered a checkmark in box 630, data (audio and video) representing the disinterested participant(s), including what is being said, may be stored for further analyses. The analyses may be profiled based on regional/cultural mannerisms as well as individual mannerisms. In this case, the location of the participants may be used for the regional/cultural mannerisms while the names of the participants may be used for the individual mannerisms. Note that regional/cultural and individual mannerisms must have already been entered in the system in order for the analyses to be so based.

As an example of regional/cultural mannerisms, in some Asian cultures (e.g., Japanese culture) the outward display of anger is greatly discouraged. Indeed, although angry, a Japanese person may display a courteous smile. If an analysis consists of identifying participants who display happiness and if a smile is interpreted as an outward display of happiness, then after consulting the regional/cultural mannerisms, the computer system may not automatically infer that a smile from a person located in Japan is a display of happiness.

An individual mannerism may be that of a person who has a habit of nodding his/her head. In this case, if the computer system is requested to identify all participants who are in agreement with a certain proposition, the system may not automatically infer that a nod from the individual is a sign of agreement.

The analyses may be provided graphically. For example, participants' expressions may be charted against time on a graph. FIG. 8 depicts an example of an expression exhibited by two participants charted against time. In FIG. 8, two participants (V and S) in a videoconference are listening to a sales pitch from a speaker. The speaker being concerned with whether the pitch will be stimulating to the participants may have requested that the system identify any participant who is disinterested in the pitch. Thus, the speaker may have entered “DISINTERESTED” in box 605 of FIG. 6. Further, the speaker may have also entered a check mark in “ANALYZE RESULT” box 635. A check mark in box 635 instructs the computer system 400 to analyze the result in real-time. Consequently, the analysis (i.e., FIG. 8) may be displayed in an alternate window on monitor 406.

In any case, two minutes into the presentation, the speaker introduces the subject of the conference. At that point, V and S are shown to display the highest level of interest in the topic. Ten minutes into the presentation, the interest of both participants begin to wane and is shown at half the highest interest level. Half an hour into the presentation, the interest level of V is at two while that of S is at five. Thus, the invention may be used in real time or in the future (if STBRE RESULT box 630 is selected) as a speech analysis tool.

Note that instead of charting expressions of participants over time, the invention may provide percentages of time participants display an expression or percentages of participants who display the expression or percentages of participants who display some type of expression during the conference or any other information that the user may desire. To display a percentage, the system may use the length of time the expression was displayed against the total time of the conference. For example, if the system is to display the percentage of time a participant displays an expression, the system may search stored data for data that represents the participant displaying the expression. This length of time or cumulative length of time, in cases where the participant displayed the expression more than once, may be used in conjunction with the length of time of the conference to provide the percentage of time the participant displayed the expression during the conference.

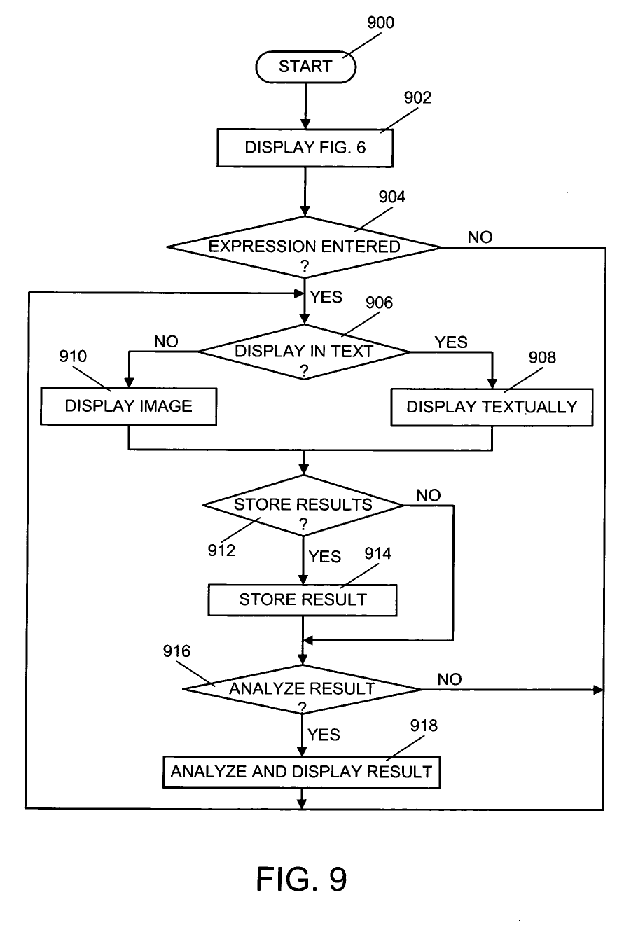

FIG. 9 is a flowchart of a process that may be used by the invention. The process starts when a videoconference software is instantiated by displaying FIG. 6 (steps 900 and 902). A check is then made to determine whether an expression is entered in box 605. If not, the process ends (steps 904 and 920).

If an expression is entered in box 605, another check is made to determine if a participant who exhibits the entered expression is to be identified textually or by images. If a participant is to be identified by images, an image of any participant who exhibits the expression will be displayed on screen 406, otherwise the participant(s) will be identified textually (steps 906, 908 and 910).

A check will also be made to determine whether the results are to be stored. If so, digital data representing any participant who exhibits the expression as well as audio data representing what was being said at the time will be stored for future analyses (steps 912 and 914). If not, the process will jump to step 916 where a check will be made to determine whether any real time analysis is to be undertaken. If so, data will be analyzed and displayed as the conference is taking place. These steps of the process may repeat as many times as there are participants exhibiting expression(s) for which they are being monitored. The process will end upon completion of the execution of the videoconference application (steps 916, 918 and 920).

The description of the present invention has been presented for purposes of illustration and description, and is not intended to be exhaustive or limited to the invention in the form disclosed. Many modifications and variations will be apparent to those of ordinary skill in the art. For example, the videoconferencing system 400 may be a cellular telephone with a liquid crystal diode (LCD) screen and equipped with a video camera.

Further, the invention may also be used in face-to-face conferences. In those cases, video cameras may be focused on particular participants (e.g., the supervisor of the speaker, the president of a company receiving a sales pitch). The images of the particular participants may be recorded and their expressions analyzed to give the speaker real time feedback as to how they perceive the presentation. The result(s) of the analysis may be presented on an unobtrusive device such as a PDA, a cellular phone etc.

Thus, the embodiment was chosen and described in order to best explain the principles of the invention, the practical application, and to enable others of ordinary skill in the art to understand the invention for various embodiments with various modifications as are suited to the particular use contemplated.

1. A speech making improvement method using stored data, the data being audio and video data of participants at a conference, the method comprising the steps of:
indicating an expression that may have been exhibited by the participants during the conference to search for;
determining, using the stored data in conjunction with an automated facial decoding system, whether at least one participant exhibited the indicated expression; and
analyzing the video data representing the at least one participant exhibiting the expression and the audio data representing what was being said when the at least one participant exhibited the expression to improve a speaker's speech making ability.

2. The method of claim 1 wherein the analyzing step includes the step of charting expressions exhibited by the at least one participant over time.

3. The method of claim 1 wherein the analyzing step includes the step of displaying a percentage of time the expression is exhibited by the at least one participant.

4. The method of claim 1 wherein the analyzing step includes the step of displaying a percentage of participants who exhibited the expression.

5. The method of claim 1 wherein the analyzing step includes the step of displaying a percentage of time participants exhibited an expression.

6. The method of claim 1 wherein the step of determining includes the step of passing the data through a regional/cultural filter for filtering out the expression if it is a regionally/culturally based expression.

7. The method of claim 1 wherein the determining step includes the step of passing the data through an individual filter for filtering out the expression if it is an expression particular to the participant.

8. The method of claim 1 wherein the determining step includes the step of passing the data through an individual filter for filtering out the expression if it is an expression particular to the participant.

9. A computer program product on a computer readable medium for improving speeches using stored data, the data being audio and video data of participants at a conference, the computer program product comprising:
code means for enabling a user to indicate an expression that may have been exhibited by the participants during the conference to search for;
code means for determining, using the stored data in conjunction with an automated facial decoding system, whether at least one participant exhibited the indicated expression; and
code means for analyzing the video data representing the at least one participant exhibiting the expression and the audio data representing what was being said when the at least one participant exhibited the expression to improve a speaker's speech making ability.

10. The computer program product of claim 9 wherein the code means for analyzing includes code means for charting expressions exhibited by the at least one participant over time.

11. The computer program product of claim 9 wherein the analyzing code means includes code means for displaying a percentage of time the expression is exhibited by the at least one participant.

12. The computer program product of claim 9 wherein the analyzing code means includes code means for displaying a percentage of participants who exhibited the expression.

13. The computer program product of claim 9 wherein the analyzing code means includes code means for displaying a percentage of time participants exhibited an expression.

14. The computer program product of claim 9 wherein the determining code means includes code means for passing the data through a regional/cultural filter for filtering out the expression if it is a regionally/culturally based expression.

15. The computer program product of claim 9 wherein the determining code means includes code means for passing the data through an individual filter for filtering out the expression if it is an expression particular to the participant.

16. The computer program product of claim 9 wherein the determining code means includes code means for passing the data through an individual filter for filtering out the expression if it is an expression particular to the participant.

17. A speech making improvement apparatus using stored data, the data being audio and video data of participants at a conference, the apparatus comprising:
means for indicating an expression that may have been exhibited by the participants during the conference to search for;
means for determining, using the stored data in conjunction with an automated facial decoding system, whether at least one participant exhibited the indicated expression; and
means for analyzing the video data representing the at least one participant exhibiting the expression and the audio data representing what was being said when the at least one participant exhibited the expression to improve a speaker's speech making ability.

18. The apparatus of claim 17 wherein the analyzing means includes means for charting expressions exhibited by the at least one participant over time.

19. The apparatus of claim 17 wherein the analyzing means includes means for displaying a percentage of time the expression is exhibited by the at least one participant.

20. The apparatus of claim 17 wherein the analyzing means includes means for displaying a percentage of participants who exhibited the expression.

21. The apparatus of claim 17 wherein the analyzing means includes means for displaying a percentage of time participants exhibited an expression.

22. The apparatus of claim 17 wherein determining means includes means for passing the data through a regional/cultural filter for filtering out the expression if it is a regionally/culturally based expression.

23. The apparatus of claim 17 wherein the determining means includes means for passing the data through an individual filter for filtering out the expression if it is an expression particular to the participant.

24. The apparatus of claim 17 wherein the determining means includes means for passing the data through an individual filter for filtering out the expression if it is an expression particular to the participant.

25. A speech making improvement system using stored data, the data being audio and video data of participants at a conference, the system comprising:
at least one storage device for storing code data; and
at least one processor for processing the code data to enable a user to indicate an expression that may have been exhibited by the participants during the conference to search for, to determine, using the stored data in conjunction with an automated facial decoding system, whether at least one participant exhibited the indicated expression, and to analyze the video data representing the at least one participant exhibiting the expression and the audio data representing what was being said when the at least one participant exhibited the expression to improve a speaker's speech making ability.

26. The system of claim 25 wherein the code data is further processed to chart expressions exhibited by the at least one participant over time.

27. The system of claim 25 wherein the code data is further processed to display a percentage of time the expression is exhibited by the at least one participant.

28. The system of claim 25 wherein the code data is further processed to display a percentage of participants who exhibited the expression.

29. The system of claim 25 wherein the code data is further processed to display a percentage of time participants exhibited an expression.

30. The system of claim 25 wherein the code data is further processed to pass the data through a regional/cultural filter for filtering out the expression if it is a regionally/culturally based expression.
